(19) United States
(12) Patent Application Publication
(10) Pub. No.: US 2010/0223494 A1
(43) Pub. Date: Sep. 2, 2010

(54) SYSTEM AND METHOD FOR PROVIDING IP PBX SERVICE

(76) Inventors: Tristan Barnum Degenhardt, San Diego, CA (US); Joshua Stephens, San Diego, CA (US); Brian Mason Degenhardt, San Diego, CA (US); David Podolsky, San Diego, CA (US)

Correspondence Address: BRADLEY ARANT BOULT CUMMINGS LLP, 200 CLINTON AVE. WEST, SUITE 900, HUNTSVILLE, AL, 35801, US

(21) Appl. No.: 12/722,452

(22) Filed: Mar. 11, 2010

Related U.S. Application Data
(63) Continuation-in-part of application No. 12/640,209, filed on Dec. 17, 2009.
(60) Provisional application No. 61/138,318, filed on Dec. 17, 2008.

(51) Int. Cl. G06F 11/20

(52) U.S. Cl. 714/4; 714/E11.073

(57) ABSTRACT

A telecommunications system has been developed that includes an on-premise IP PBX and an offsite hosted IP PBX. The system includes logic that automatically and/or manually migrates system configuration data from the on-premise IP PBX to the offsite IP PBX during a failure of the on-premise IP PBX.

### CROSS-REFERENCE TO RELATED APPLICATIONS

This application claims priority as a continuation-in-part of U.S. patent application Ser. No. 12/640,209 entitled “SYSTEM AND METHOD FOR PROVIDING IP PBX SERVICE” that was filed on Dec. 17, 2009 which claims priority from U.S. Provisional Patent Application No. 61/138,318 entitled “SYSTEM AND METHOD FOR PROVIDING IP PBX SERVICE” that was filed on Dec. 17, 2008 which is incorporated herein by reference. This application is related to U.S. patent application Ser. No. 11/585,787 filed on Oct. 24, 2006 entitled “Method and Apparatus for Converting Parallel Bit Data into Multi-Port Steered Serial Data Stream”, which is incorporated herein by reference. This application is also related to U.S. Pat. No. 6,795,448 issued on Sep. 21, 2004 entitled “IP Packet Ready PBX Expansion Circuit for a Conventional Personal Computer with Expandable, Distributed DSP Architecture” and U.S. Pat. No. 7,023,867 issued on Apr. 4, 2006 entitled “PBX with Configurable Analog CO Line and T1 Signaling Protocols Using Packet Bus and Software Switch WAV Channels DSP Architecture”, which are both incorporated herein by reference.

### FIELD OF THE INVENTION

The invention relates generally to telecommunications methods and hardware. More specifically, the invention relates to private branch exchange systems of telecommunications services.

### BACKGROUND ART

A private branch exchange (PBX) typically is used to provide telephony services to a relatively large number of users. For example, a business may use a PBX to provide telephone services between employees. A primary function of a PBX is to direct signals between various telecommunication devices that are coupled to the PBX. For example, an incoming signal may be switched from one connection to any of a large number of other connections depending on the ultimate destination of the incoming signal. To enhance the telecommunication service provided to users, current PBXs typically provide many optional features such as call transfer, auto attendant, voicemail, call forwarding, automatic ring back, conference call and others.

Historically, implementing a PBX has been expensive and difficult to afford for many small businesses and individuals. However, since the 1990′s, there has been an increasing number of “off-the-shelf’ solutions, including consumer-grade and consumer-size PBXs. These PBXs are not generally comparable in size, robustness or flexibility to commercial-grade PBXs, but still provide an attractive set of features.

Some proponents of more recent open source projects claim that their initiatives have finally brought PBXs within the reach of even more individuals and small businesses. The mentioned open source projects provide more flexibility and more features (often not needed or understood by average users) on standard hardware platforms, plus the ability to actually inspect and change the inner working of a PBX, They have also opened business opportunities for newcomers to the market of mid-size PBX, since they have lowered the entry barrier for new manufacturers.

Typically, in order for a personal computer (PC) to serve as an element of a PBX, the PC is linked or coupled to telecommunication interface modules. A link should be adaptable so that a variety of telecommunication interface modules can be coupled to the personal computer. Further, a link should provide a full duplex exchange of control information and telecommunication data between the personal computer and the telecommunication interface modules. One component typically included in the link is a conversion circuit (converter). Converters are generally expensive and often have little or no flexibility in providing custom PBX features. Thus, while various solutions permit smaller business and individuals to utilize PBX functionality, many solutions are still quite expensive to upgrade and to expand their functionality.

### SUMMARY OF THE INVENTION

In some aspects, the invention relates to a telecommunications system, comprising: a first IP PBX located at a first site and configured for coupling to IP user devices; a second IP PBX located at a second site and coupled to the first IP PBX over a packet network, the second IP PBX configured for coupling to IP user devices; and logic for automatically initiated migration from the first IP PBX to the second IP PBX when a failure of the first IP PBX occurs wherein the first IP PBX and the second IP PBX have an optimized premise PBX software.

In other aspects, the invention relates to a telecommunications system, comprising: a first IP PBX located at a first site and configured for coupling to IP user devices; a second IP PBX located at a second site and coupled to the first IP PBX over a packet network, the second IP PBX configured for coupling to IP user devices; and means for transferring the configuration of the first IP PBX to the second IP PBX when a failure of the first IP PBX occurs.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 depicts a prior art communication system providing services with a premise IP PBX.

FIG. 2 depicts a prior art communication system providing services with a host IP

PBX.

FIG. 3 depicts one embodiment of communication system of the present disclosure.

FIG. 4 depicts a method embodiment of the communication system of FIG. 3.

FIG. 5 depicts a method embodiment of the communication system of FIG. 3.

### DETAILED DESCRIPTION

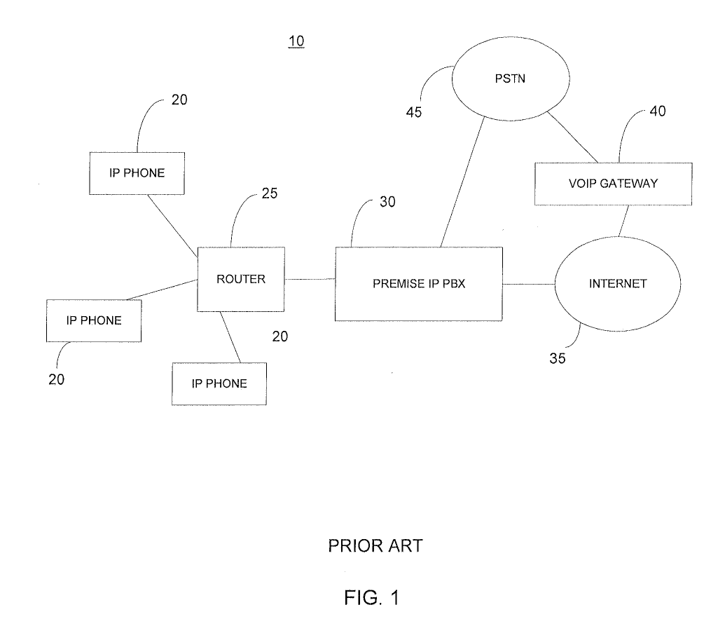

FIG. 1 depicts a conventional internet protocol IP telecommunication system 10 having a premise IP private branch exchange (PBX) 30. The premise IP PBX 30 is comprised of a premise server having PBX software, such as Switchvox™ software from Digium or another source. One or more IP phones 20 are connected to a router 25 and the router is coupled to the premise IP PBX 30. The premise IP PBX is in communication with the public switched telecommunication network (PSTN) 45 via a central office or other PSTN connection point. Phone call packets are coupled to the internet 35 and through a VOIP gateway 40 having a PSTN ports going to the PSTN 45. The premise IP PBX software operates on a personal computer using a Microsoft operating system or other operating system. The premise software is developed to interact with a PC operating system.

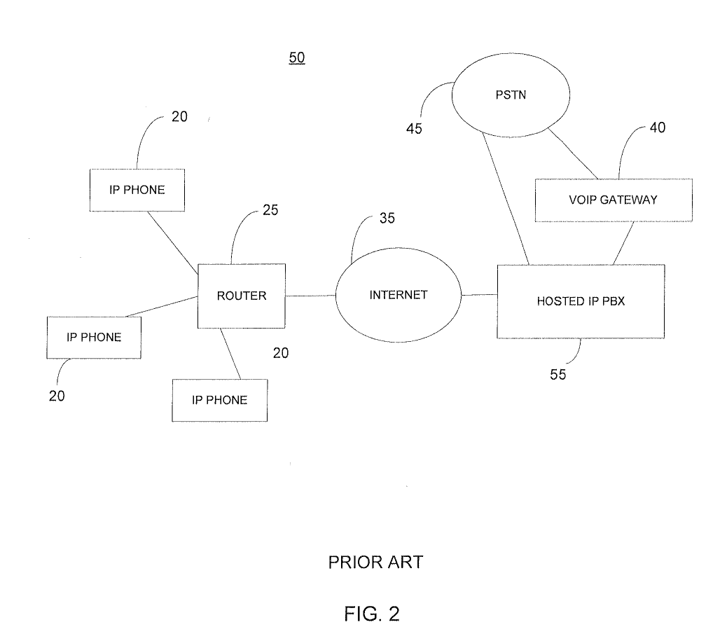

FIG. 2 depicts a conventional Internet protocol IP telecommunication system 50 having a hosted P PBX 55. The hosted P PBX 55 is comprised of a host server having hosted PBX software. One or more IP phones 20 are connected to a router 25 and the route 25 is coupled over the Internet 35 to the hosted IP PBX 55. The hosted IP PBX 55 is in communication with the (PSTN) 45 via a central office or other PSTN connection point. Phone call packets are coupled through hosted IP PBX 55 through a VOIP gateway 40 having a PSTN ports going to the PSTN 45. The hosted IP PBX software operates on a server using an operating system suitable for a hosted server and may include a system such as Fedora Core 6 and XEN Virtualization. The hosted server may provide multiple hosted PBXs, for example 20 PBXs. The hosted server typically has significant processing power, disk space and memory when compared with a PC that is used at a premise. Hence, the hosted PBX software installed on the conventional hosted PBX is incompatible with the premise PBX software of the premise PBX 30.

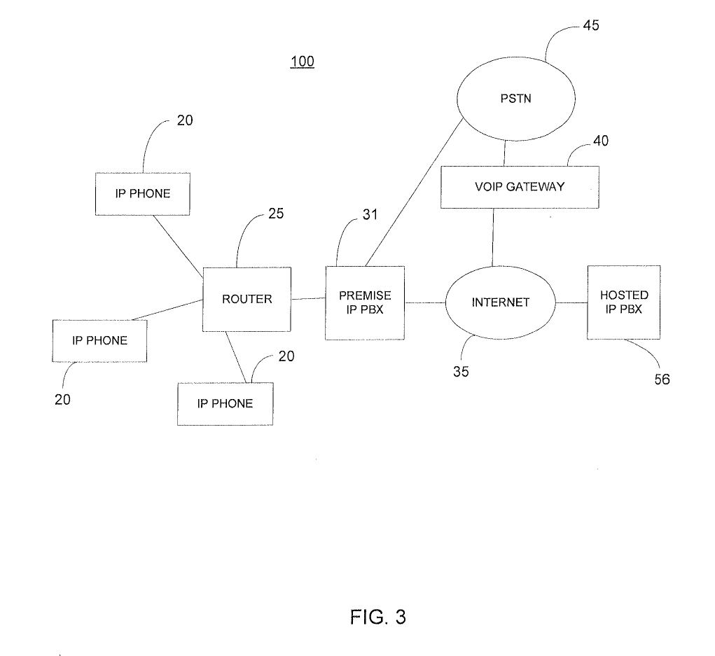

An embodiment of communication system 100 in accordance with the present disclosure is depicted in FIG. 3. In one embodiment, the communication system 100 a modified premise IP PBX 31 and modified hosted PBX 56 are coupled via the Internet 35. The modified premise IP PBX 31 utilizes software adapted to function on a personal computer (PC) operating systems or on a server operating system. In addition the modified hosted PBX 56 utilizes the same PBX software installed on the modified premise IP PBX 31.

In one embodiment the modified premise IP PBX 31 provides exchange service for the IP phones 20 and other device typically attached to a branch exchange. In the event of failure of the modified premise IP PBX 31 a notification signal activates the modified hosted IP PBX 56 to provide service to IP devices that were using the modified premise IP PBX 31. The modified hosted IP PBX 56 provides service until premise available notification is received. The time to migrate between the PBXs 31, 56 is seamless and essentially undetected by a user. The premise available notification is sent from the premise when the failure of the modified premise IP PBX 31 is resolved.

For some customer having limited PBX needs, such as having 2 or 3 IP phones, a hosted IP PBX is the best value. However, as the needs of the customer increase it is often advantageous to migrate from a hosted system to a premise system. The structure shown in FIG. 3 depicts how the migration from a hosted system to a premise system is provided. During a first period of time, when the user has hosted service, router 25 is connected to the modified hosted PBX 56 via the internet 35. When a user desires to have a premise system a modified premise IP PBX 31 is installed. When an availability signal is sent to the modified hosted IP PBX 56 information, including user profiles, features, call history and other data, is transferred to the modified premise IP PBX 31. Because the tuned software for providing PBX service is identical on the PC and the server, the migration is seamless and usually undetected by the user. The ease of migration allows for other embodiments of other communication arrangements in the PBX arena.

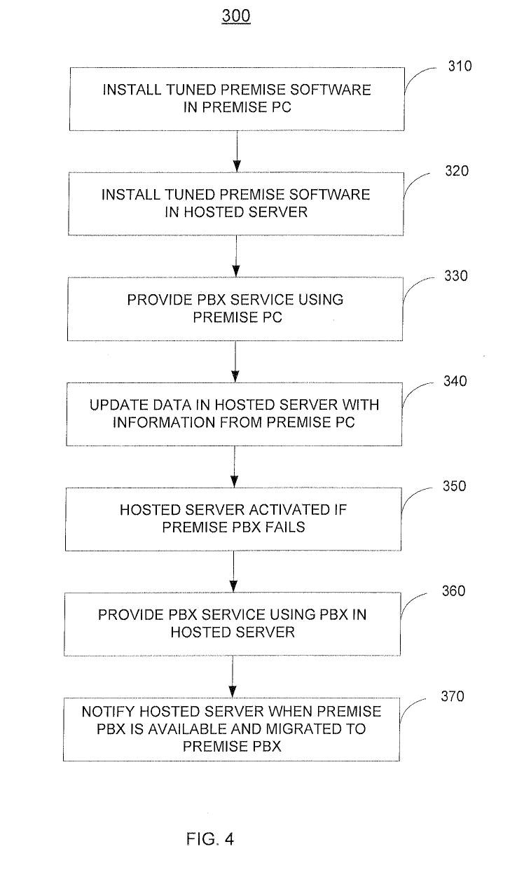

A method embodiment for providing IP PBX backup is depicted in FIG. 4. A tuned premise software adapted for PC and server operating systems is installed on a premise PC and a hosted server 310 and 320. PBX service is then provided by the premise PC 330. In other that the hosted server be available to serve as a backup, a data base in the hosted server is updated periodically so that appropriated data at the premise PC and at the hosted server are essentially the same in the event that the premise PC fails, so that it cannot provide exchange serve, an alarm is sent to the hosed server for enabling migration of exchange service 350. Upon receiving the alarm, the hosted server provides exchange service. If the premise exchange problem is resolved, an available notification is sent to the hosted server and exchange service migrated back to the premise PC 370.

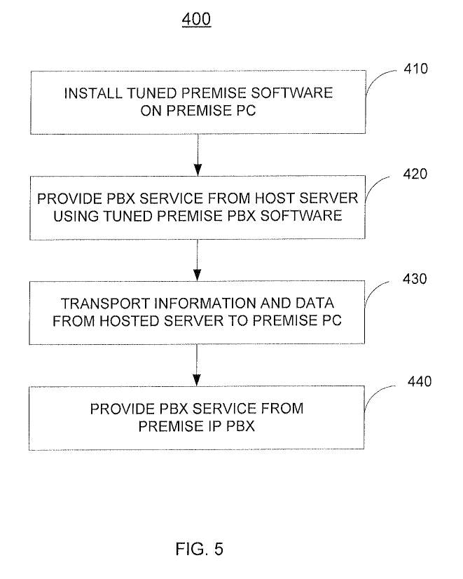

A method embodiment for migrating from a hosted exchange service to a premise exchange service 400 is depicted in FIG. 5. When a customer has limited exchange service needs, such as having 2 or 3 phones, then a hosted exchange service is cost effective. In addition, some prospective customers may want to evaluate an IP exchange service to determine if such a system is desirable for their needs. In either of the above scenarios or others, some users will desire to migrate from a hosted system to a premise system. if a modified premise PBX 31 has tuned premise software, installed in 410, then it is possible to seamlessly migrate from a hosted exchange system to a premise system. A customer being provided hosted service as indicated by 420 desires to migrate, then information on the hosted server is transported to the premise PC 430. Service is then provided by the modified premise IP PBX 440.

The disclosure is a system that allows a seamless transition to and from a premises PBX solution and a hosted PBX solution. The system creates, stores, and shares a platform-agnostic, abstracted representation of a system's configuration (an ‘abstracted snapshot’), and to applies the abstracted snapshot seamlessly to an on-premises system or to a hosted system. This system is useful to consumers because it offers a seamless upgrade to a more robust system, it is also useful because it offers a seamless process for failing over to a different system.

For example, a small company with 5 employees chooses to use a Switchvox™ hosted service for their telecommunications needs. As the business grows, and the business may be employing 30 people and have outgrown the hosted system, and now it is desired to have their own system on-premises. With Switchvox™, they simply plug in a new Switchvox™ computer at their premises, and apply the abstracted snapshot from their hosted system. All of their extensions, voicemail, IVRs etc., along with historical logs, are available to them and their telecommunications system is intact and functioning as normal.

For example, if failover occurs there is a seamless migration. A company with 200 employees desires to ensure that their telecommunications system has minimal downtime. A primary system is on-premises, and a remote failover system available in the event that their premises system fails. With Switchvox™, they establish a periodic upload of their on-premises abstracted snapshot to the remote failover system. In the event that their primary on-premises system fails, they apply the abstracted snapshot to the remote system, with minimal downtime and little fuss, their telecommunications system is intact and functioning as normal. The migration of the snapshot can be automatic and/or manual. A manually initiated migration will be needed to restore the most recent data that was accumulated since the last backup.

The Switchvox™ software that enables the software to operate seamlessly in the hosted IP PBX and the premise IP PBX is a platform-agnostic, abstracted representation of a consumer's system is what allows the seamless transition to another system. There is code that creates, stores, and uploads this abstract snapshot and may be a component of the disclosure. In another embodiment, Asterisk™ is the software component within Switchvox™ that provides tile calling capabilities including most of the phone system functions.

The premise PBX and hosted PBX of the disclosure perform call processing duties including: establishing connections (circuits) between the telephone sets of two users (e.g., mapping a dialed number to a physical phone, ensuring the phone isn't already busy); maintaining such connections as long as the users require them (e.g., channeling voice signals between the users); disconnecting those connections as per the user's requirement; and providing information for accounting purposes (e.g., metering calls).

In addition to the above functions, the disclosed system may offer other advantages. The premise PBX and hosted PBX combination can provide a user with growth or shrinkage capabilities with the use of multiple premise PBX systems at a users location. While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A telecommunications system, comprising:
a first IP PBX located at a first site and configured for coupling to IP user devices;
a second IP PBX located at a second site and coupled to the first IP PBX over a packet network, the second IP PBX configured for coupling to IP user devices; and
logic for automatically initiated migration from the first IP PBX to the second IP PBX when a failure of the first IP PBX occurs wherein the first IP PBX and the second IP PBX have an optimized premise PBX software.

2. The system of claim 1, where the migration transfers an abstracted representation of the first IP PBX's configuration to the second IP PBX.

3. The system of claim 2, where the abstracted representation of the first IP PBX's configuration is created by periodically storing system configuration of the first IP PBX.

4. The system of claim 3, where the migration from the first IP PBX to the second IP PBX is initiated manually.

5. The system of claim 4, where the manually initiated migration includes system data from the first IP PBX that was accumulated since the latest periodic creation of the abstracted representation of the first IP PBX's configuration.

6. The system of claim 1, where the system includes a plurality of first IP PBXs located at the first site.

7. A telecommunications system, comprising:
a first IP PBX located at a first site and configured for coupling to IP user devices;
a second IP PBX located at a second site and coupled to the first IP PBX over a packet network, the second IP PBX configured for coupling to IP user devices; and
means for transferring the configuration of the first IP PBX to the second IP PBX when a failure of the first IP PBX occurs.
